(19) United States
(12) Patent Application Publication
(10) Pub. No.: US 2016/0171627 A1
(43) Pub. Date: Jun. 16, 2016

(54) PROCESSING ELECTRONIC DOCUMENTS FOR INVOICE RECOGNITION

(71) Applicant: ABBYY Development LLC, Moscow (RU)

(72) Inventor: Dmitry Lyubarskiy, Moscow (RU)

(21) Appl. No.: 14/678,202

(22) Filed: Apr. 3, 2015

(30) Foreign Application Priority Data
Dec. 15, 2014 (RU) 2014150658

(51) Int. Cl. G06Q 40/00; G06F 17/30

(52) U.S. Cl. CPC G06Q 40/12; G06F 17/30253; G06F 17/30268

(57) ABSTRACT

Embodiments for processing electronic documents for invoice recognition are disclosed. A method of the disclosure includes receiving, using a processing device, an image of an invoice for at least one purchase order; identifying, using the processing device, a portion of the image comprising a tabular structure having a plurality of records, the tabular structure storing data representing a plurality of order items of the at least one purchase order, the plurality of order items having a plurality of data fields, wherein each order item comprises one or more of the plurality of records and one or more of the plurality of data fields; and recognizing, using the processing device, the plurality of order items in the image of the invoice.

### CROSS REFERENCE TO RELATED APPLICATIONS

This application claims the benefit of priority to Russian Patent Application No. 2014150658, filed Dec. 15, 2014; disclosure of which is incorporated herein by reference in its entirety.

### TECHNICAL FIELD

The embodiments of the disclosure relate generally to processing electronic documents and, more specifically, relate to processing electronic documents for invoice recognition.

### BACKGROUND

An electronic document including an image of an invoice can be obtained by scanning the invoice or otherwise acquiring an image of the invoice. A business may need to handle a large volume of invoices for accounting, financing, and other purposes. Businesses can rely on accountants, bookkeepers, etc. to process invoices. For example, a bookkeeper of a business may have to manually enter data contained in invoices into a software product in order to compare information contained in the invoices with information related to accounts payable. This process may present an ominous task given the volume of invoices that a business might need to process.

Conventional invoice recognition tools can simplify this task by processing scanned images of invoices using Optical Character Recognition (OCR) to convert a scanned image of the invoice into computer-readable text, and then recognizing various data fields of the invoice from the computer-readable text. However, conventional invoice recognition tools typically need to know in advance the invoice format used by a particular vendor that generated the invoice.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram of a computing device operating in accordance with an embodiment of the disclosure;

FIG. 2 is an example of an image of an invoice according to an embodiment of the disclosure;

FIG. 3 is a flow diagram illustrating a method for processing electronic documents for invoice recognition according to an embodiment of the disclosure;

FIG. 4 is a flow diagram illustrating a method for identifying header elements of an invoice according to an embodiment of the disclosure;

FIG. 5A is a flow diagram illustrating a method for determining a reference record of a tabular structure according to an embodiment of the disclosure;

FIG. 5B is a flow diagram illustrating a method for determining a reference record based on pivot elements of a tabular structure according to an embodiment of the disclosure;

FIG. 6A is a flow diagram illustrating a method for recognizing order items of an invoice according to an embodiment of the disclosure;

FIG. 6B illustrates examples of patterns in data fields of a tabular structure according to an embodiment of the disclosure;

FIG. 6C illustrates examples of tabular structures according to an embodiment of the disclosure; and

FIG. 7 illustrates a block diagram of one embodiment of a computer system.

### DETAILED DESCRIPTION

Described herein are methods and systems of processing electronic documents for invoice recognition.

An electronic document can refer to a file comprising one or more digital content items that may be visually rendered to provide a visual presentation of the electronic document (e.g., on a display or a printed material). An electronic document may be produced by scanning or otherwise acquiring an image of a paper document such as an image of an invoice. An electronic document may conform to any suitable file format, such as PDF, JPEG, PNG, BMP, DOC, etc.

An invoice can include data about one or more purchase orders (e.g., a purchase order of services, a purchase order of products, etc.). Each purchase order may be associated with a tabular structure (e.g., a table or any other data structure having a tabular format) that includes order items of the purchase order. Each order item may pertain to a specific product or service reflected in the purchase order and may be represented by one or more records positioned in the tabular structure as rows, where each record may have one or more data fields positioned in corresponding columns of the tabular structure. Each column may have a header element of a purchase order and a subset of data fields. Each column may include a description of one or more data fields of the purchase order, such as “product code,” “description of goods,” “quantity,” “unit,” “unit price,” “value-added tax (VAT),” “total,” “net total value,” “total amount excluding VAT,” “VAT rate,” “VAT amount,” etc. Alternatively, a header element can correspond to a column that does not have a specified description (e.g., a column may correspond to a product code without having the actual product code description). In addition to the data fields in the tabular structure of a purchase order, the invoice may include other data fields such as a purchase order number, a total amount, an invoice number, an account number, etc. A purchase order in the invoice may or may not be associated with one or more consumption taxes (e.g., a value added tax (VAT) or a goods and services tax (GST)), and each consumption tax can be applicable to all order items of a purchase order or to only some order items of a purchase order.

Embodiments of the disclosure can process an image of an invoice to recognize data contained in the invoice. For example, embodiments of the disclosure can process the image using suitable optical character recognition (OCR) techniques to recognize elements of the invoice such as header elements of the tabular structure of a purchase order, data fields of each order item of a purchase order (e.g., data fields containing data about a description of a product, quantity of the product, a unit price of the product, etc.), a total amount of a purchase order, a purchase order number, etc.

In some embodiments, elements of an invoice and/or other information related to the invoice can be extracted from an image of the invoice automatically without user interaction. Alternatively, upon identifying one or more elements of the invoice and/or extracting other information related to the invoice, embodiments of the disclosure can prompt a user to verify the identified elements and/or extracted information (e.g., by displaying the elements and/or information using one or more user interfaces).

Aspects of the present disclosure may perform invoice recognition without knowing a format used by a vendor that generated the invoice, and may use the recognized invoice elements to derive such a format and then utilize it as a template to process invoices of the same vendor or invoices having a similar format. In addition or alternatively, a user can provide input indicating the format for the invoice or a portion of the invoice, and/or a user can verify and correct the recognized invoice elements. The user input and/or user corrections can be used to train the invoice recognition process of the present disclosure to provide more accurate results for subsequent invoices. As such, in some implementations, the output of the invoice recognition process can represent a combination of information resulting from recognizing elements of the present invoice, information obtained from processing previous invoices, and information provided by a user.

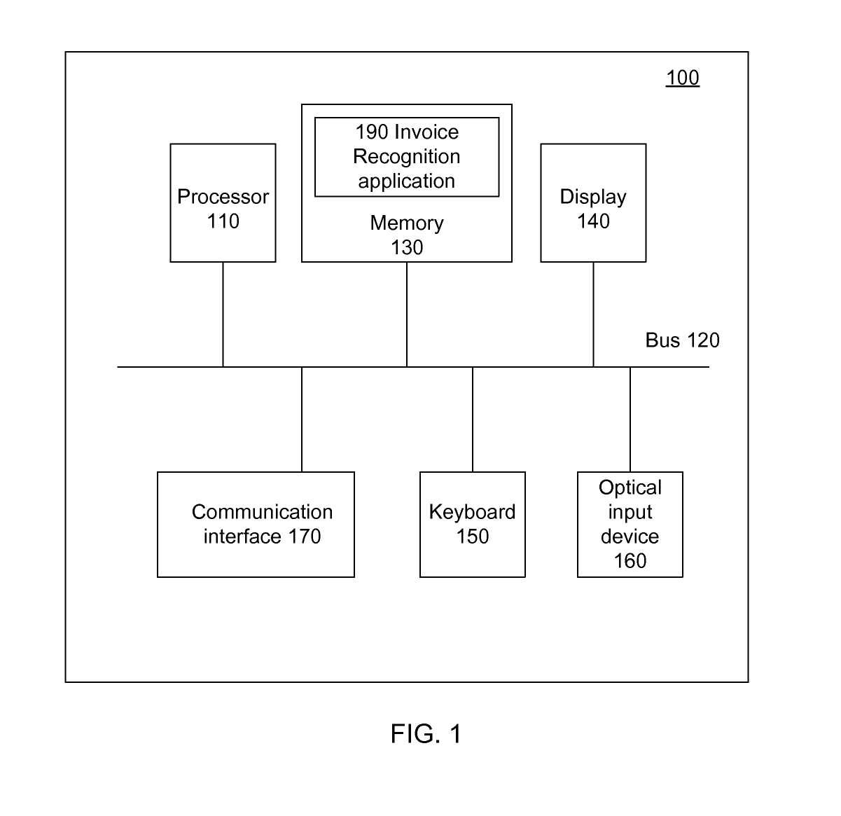

FIG. 1 depicts a block diagram of one illustrative example of a computing device 100 operating in accordance with one or more aspects of the present disclosure. In illustrative examples, computing device 100 may be provided by various computing devices including a tablet computer, a mobile phone, a laptop computer, a desktop computer, etc.

Computing device 100 may comprise a processor 110 coupled to a system bus 120. Other devices coupled to system bus 120 may include memory 130, display 140 equipped with a touch screen (optical) input device 160, keyboard 150, and one or more communication interfaces 170. The term “coupled” herein shall include both electrically connected and communicatively coupled via one or more interface devices, adapters and the like.

Processor 110 may be provided by one or more processing devices including general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks).

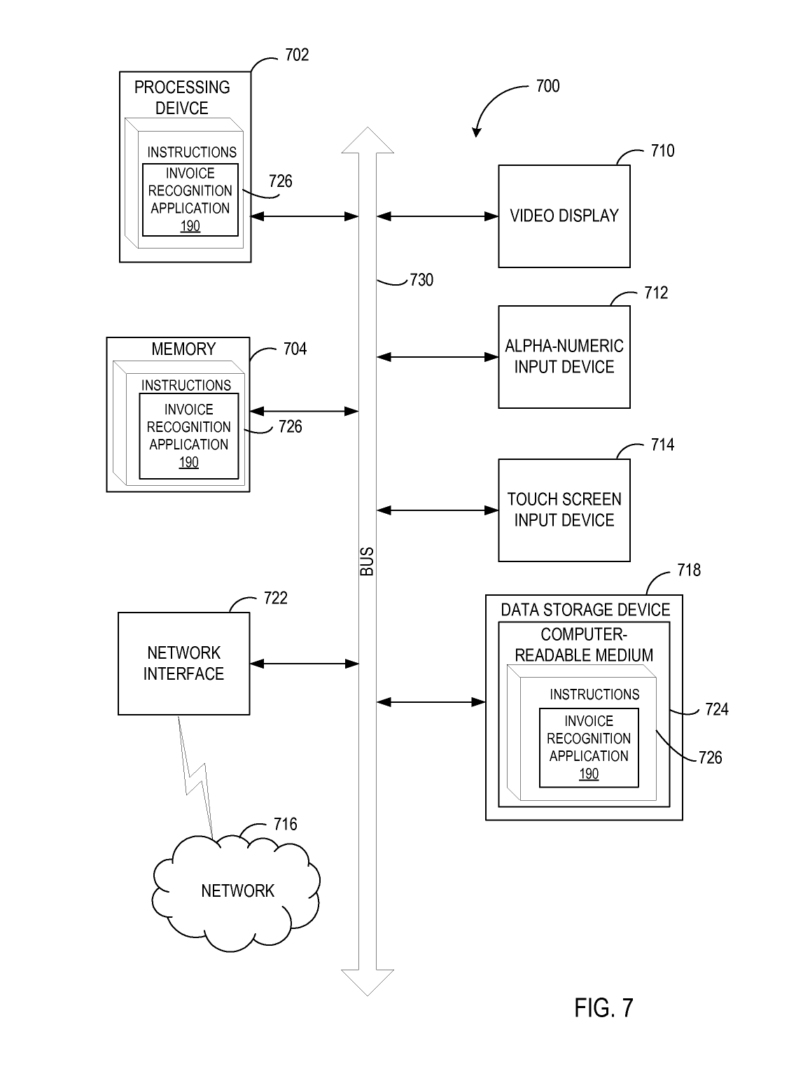

In some embodiments, computing device 100 may comprise a touch screen input device 160 represented by a touch-sensitive input area and/or presence-sensitive surface overlaid over display 140. An example of a computing device implementing aspects of the present disclosure will be discussed in more detail below with reference to FIG. 7.

In some embodiments, memory 130 may store instructions of an application 190 for processing electronic documents for invoice recognition. In one embodiment, invoice recognition application 190 may be implemented as a function to be invoked via a user interface of another application (e.g., a billing application, an accounting application, an electronic document editing application, etc.). Alternatively or additionally, invoice recognition application 190 may be implemented as a standalone application.

In an illustrative example, invoice recognition application 190 may acquire an electronic document containing an image of an invoice. The electronic document may have any suitable format, such as PDF, JPEG, PNG, BMP, etc. An image of an invoice may be represented by a data structure comprising multiple bit groups of pixels of a visual representation of the invoice. In some embodiments, an invoice may include information related to one or more purchase orders (e.g., a purchase order of services, a purchase order of products, etc.).

In some embodiments, application 190 may process the image using an optical character recognition (OCR) technique and/or any other suitable technique to recognize elements of the image. For example, application 190 may analyze the image to identify a portion that corresponds to a tabular structure and to further process this image portion to detect one or more records of the tabular structure. Application 190 may also identify other portions of the image that contain additional data fields of the invoice such as a purchase order recipient address, an invoice number, a purchase order number, a total amount, etc.

Application 190 may further process and/or analyze the records to detect sequences of characters delimited by whitespaces. Such a sequence of characters may represent, for example, a word comprising one or more letter, a number comprising one or more digits, one or more symbols, etc. Based on the detected sequences of characters, application 190 can recognize data fields included in a record, where each data field can contain one or more sequences of characters. Additionally, application 190 can determine locations of the recognized data fields in the invoice. Application 190 can include the OCR functionality or can be a separate program or module that utilizes the output of an OCR application.

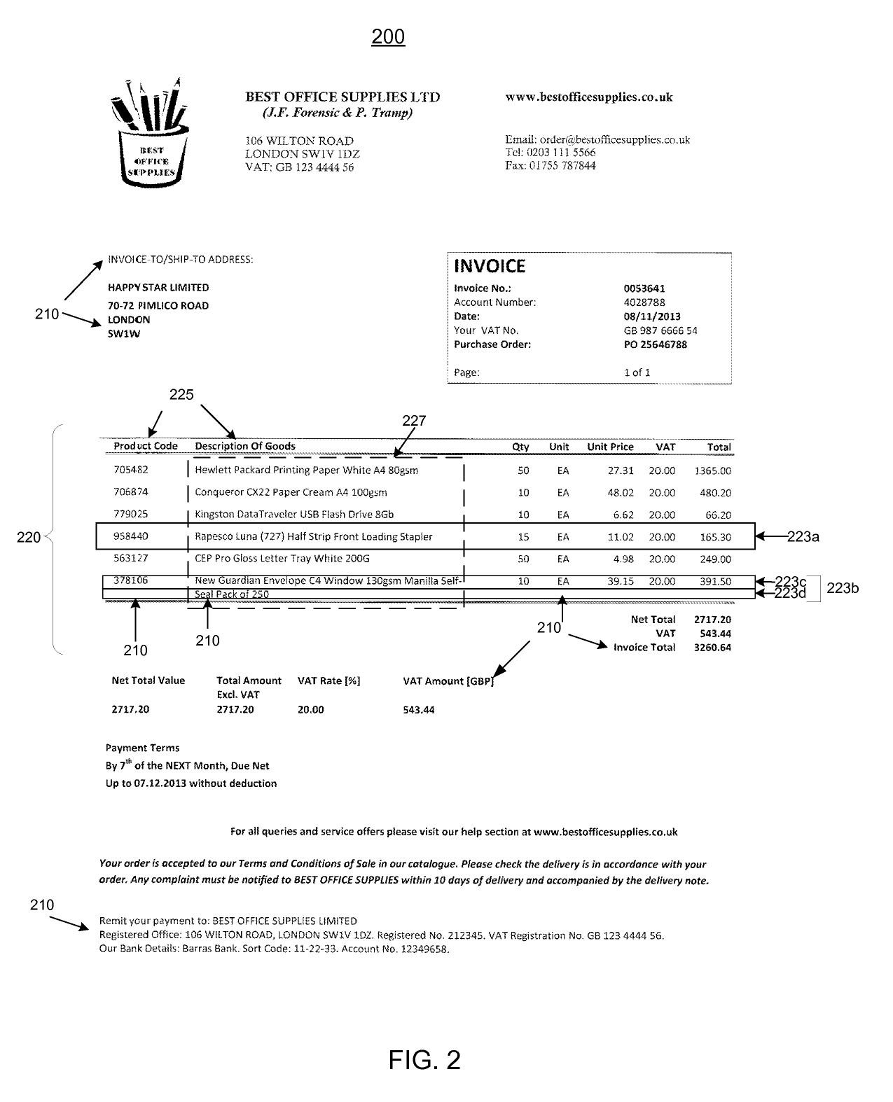

FIG. 2 illustrates an example of an image 200 that may be processed by invoice recognition application 190 running on computing device 100 in accordance with one or more aspects of the present disclosure.

Application 190 can process image 200 and recognize data fields 210 within image 200 (e.g., using an OCR technique). Each data field 210 can include one or more sequences of characters recognized as described above. In other words, a data field can refer to any data or block of data recognized by OCR (e.g., any computer readable text or characters recognizable by OCR). For example, a data field may be an invoice element containing the text “unit” or “unit price.” Initially, application 190 does not know whether a particular data field corresponds to a header element or an order item of a purchase order, or to something not directly related to the purchase order (e.g., contact information of the vendor). Application 190 can then use one or more methods discussed herein to determine that a data field containing the text “unit price” corresponds to a header element of the purchase order (e.g., based on its text, location, data type, etc.). In some implementations, application 190 can mistakenly identify “unit price” as two data fields (i.e., a data field of “unit” and a data field of “price”) and determine that they correspond to two preliminary header elements (e.g., “unit” and “price”). As will be discussed in more detail below, application 190 may later determine that the two preliminary header elements correspond to one header element ‘unit price’ and should be combined into one header element.

Application 190 can start the invoice recognition process by identifying a portion of image 200 that contains a tabular structure 220. As shown, tabular structure 220 may include multiple data fields 210 containing data about a purchase order. Tabular structure 220 may also include one or more records 223a, 223c, 223d, each of which may include one or more data fields 210. In one embodiment, a record 223 includes data fields 210 that are recognized by application 190 using the OCR technique and/or any other suitable technique.

While one purchase order is illustrated in FIG. 2, this is merely illustrative. Alternatively, an image of an invoice can contain information related to multiple purchase orders and multiple tabular structures of data corresponding to the purchase orders.

Tabular structure 220 may include one or more header elements 225. A header element 225 may be a description of one or more data fields 210, such as “product code,” “description of goods,” “quantity,” “unit,” “unit price,” “value-added tax (VAT),” “total,” “net total value,” “total amount excluding VAT,” “VAT rate,” “VAT amount,” etc. Alternatively, a header element may correspond to a column of the tabular structure 220 that does not have a specified description.

A purchase order may include one or more order items 223a, 223b. Each order item may include one or more records 223a, 223c, 223d and data fields 210. For example, an order item corresponding to product code “958440” may include record 223a. As another example, an order item corresponding to product code “378106” may include two records 223c and 223d.

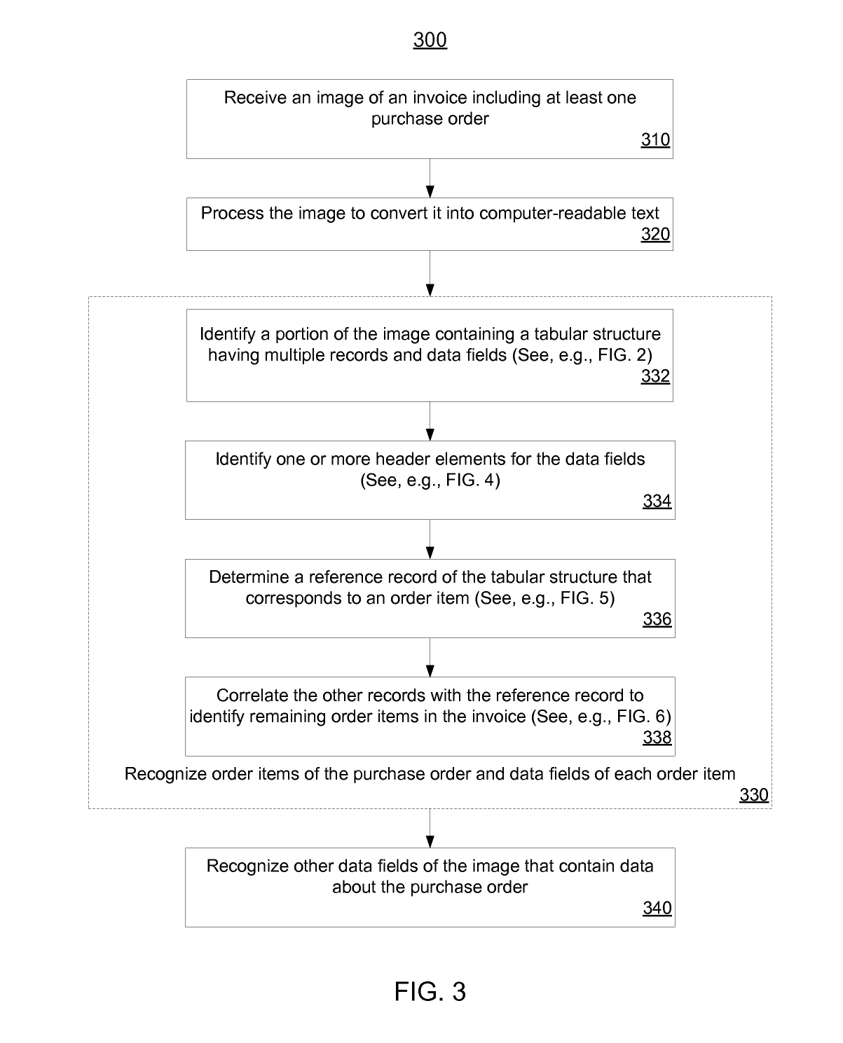

Application 190 can process and analyze image 200 to recognize elements of the purchase order, such as a purchase order number, a total amount, a header element, an order item, etc. Application 190 may identify one or more data fields as corresponding to a header element (e.g., a column of data fields 227 corresponding to a header element 225 of “description of goods”). Additionally, application 190 can identify one or more records 223 as containing data about one order item (e.g., data fields containing data about a description of a product, quantity of the product, a unit price of the product, and/or other information related to order items 230a-b). In some embodiments, elements and other information related to the invoice can be recognized by performing one or more operations as described below in connection with FIGS. 3-6.

In some embodiments, application 190 can obtain information related to elements of purchase orders from a given user that has requested invoice recognition. For example, application 190 (or any other suitable application) may prompt the user to provide positional information related to typical locations of elements of an invoice. In one embodiment, the user may provide a location of a column of data fields (e.g., the leftmost column) that corresponds to a particular element of the invoice (e.g., “description of goods”). As another example, application may prompt a user to provide one or more keywords associated with header elements of an invoice. In some embodiments, the obtained information can be stored in association with the user or any other user in a database.

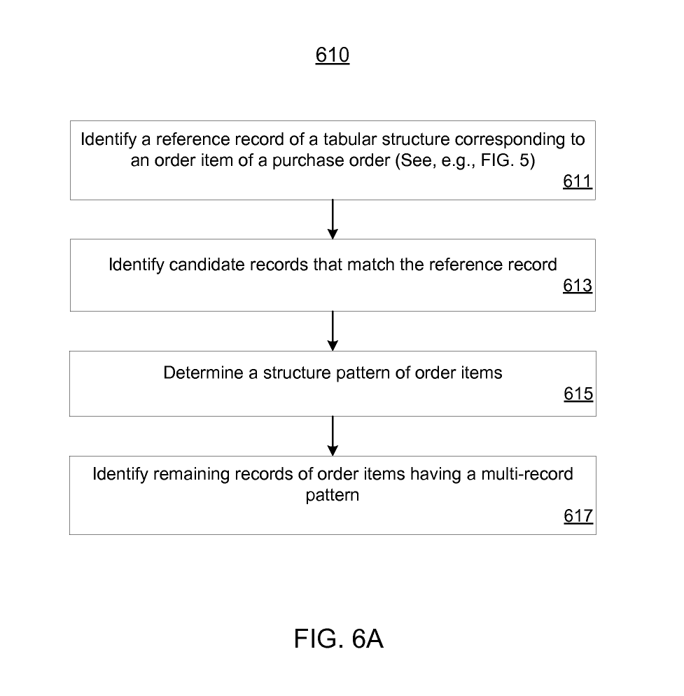

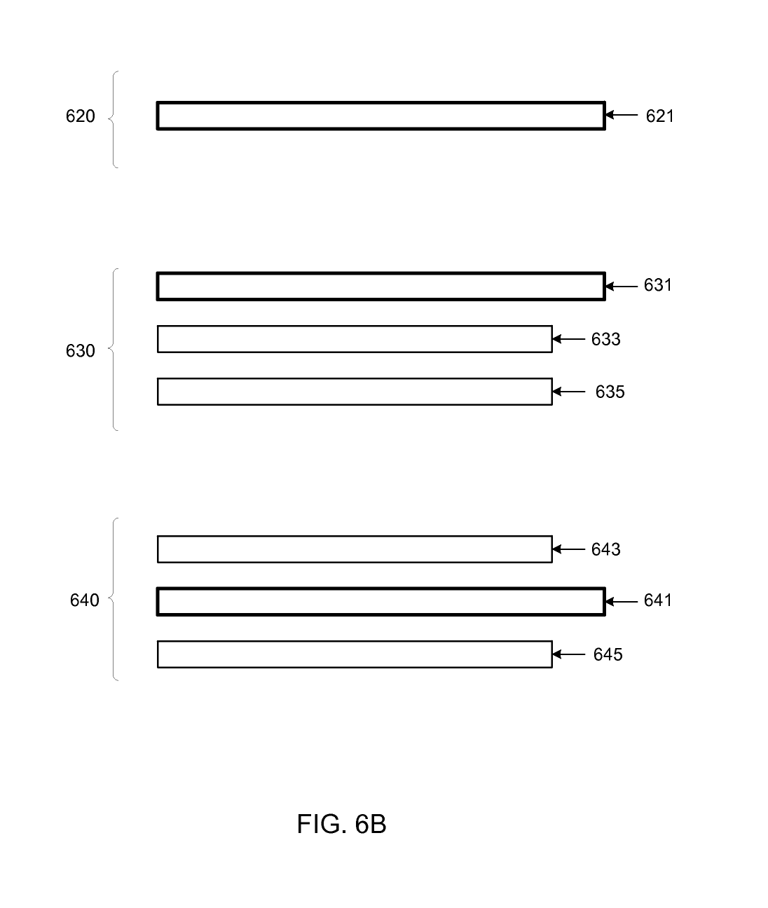

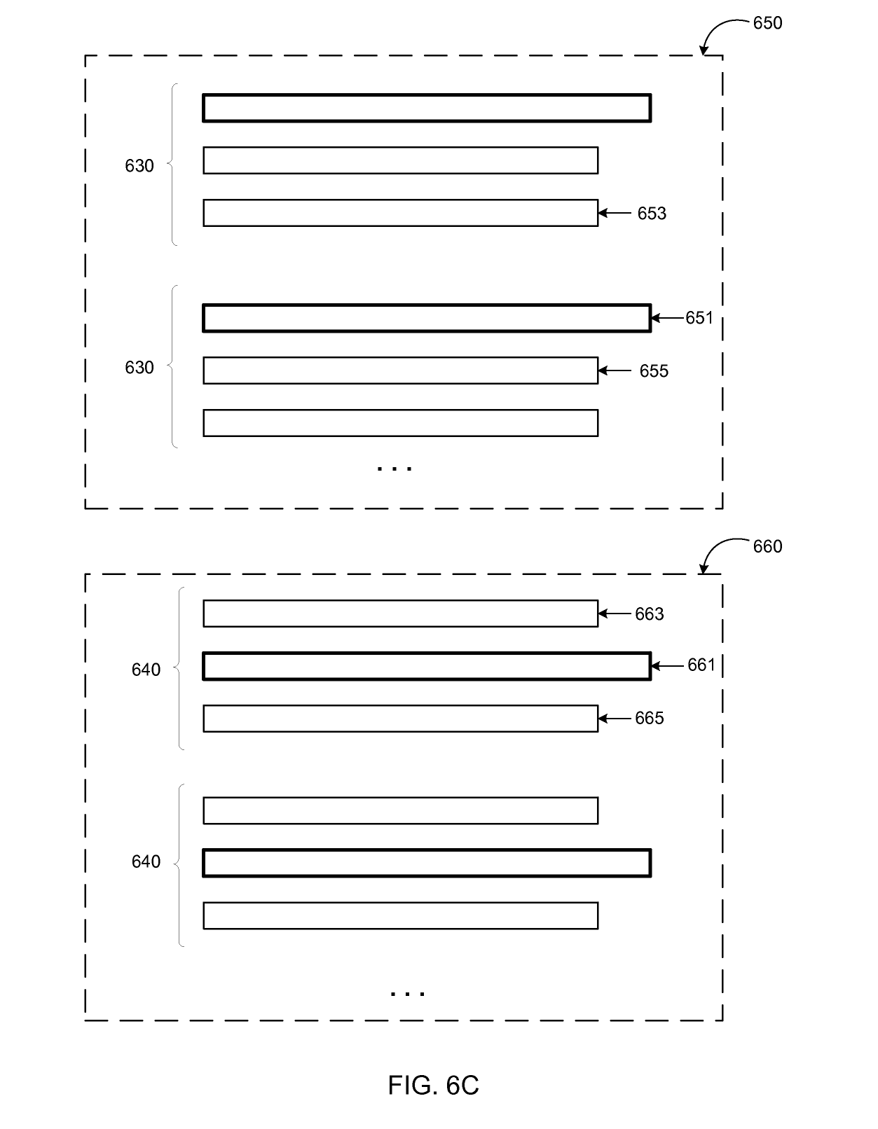

In some embodiments, application 190 can extract information of one or more invoices and/or provide the information to a user based on a user request. For example, in response to receiving a user request for purchase order numbers contained in one or more invoices, application 190 can process images of the invoices (e.g., using one or more operations of methods 300-600 of FIGS. 3 and 6) and extract data items of the invoices corresponding to the purchase order numbers. As another example, application 190 can receive a user selection of one or more portions of an invoice or multiple invoices, such as a given column of one or more invoices, multiple columns of one or more invoices, etc. Application 190 can then extract data corresponding to the portions of invoice(s). In some embodiments, the user can select/identify a column or multiple columns by inputting one or more keywords associated with a header element and/or other information related to the column.

In some embodiments, application 190 can provide a user with information about one or more invoices that is extracted as described above. For example, application 190 can cause such information to be displayed using one or more user interfaces. As another example, application 190 can generate one or more electronic documents including the extracted information. As yet another example, application 190 can provide the extracted information to another application (e.g., a billing application, an accounting application, etc.).

FIG. 3 is a flow diagram illustrating a method 300 for invoice recognition according to an embodiment of the disclosure. Method 300 and/or each of its individual functions, routines, subroutines, or operations may be performed by one or more processing devices of a computer system (e.g., computing device 100 of FIG. 1) executing the method. In some embodiments, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

Method 300 begins at block 310 where a processing device receives an image of an invoice (e.g., such as an image 200 of FIG. 2). In some embodiments, the invoice can include one or more purchase orders. Each of the purchase orders includes multiple elements, such as header elements, a purchase order number, a total amount, order items, etc.

At block 320, the processing device can process the image to convert it into computer-readable text. For example, the processing device can process the image using OCR and/or any other suitable techniques to extract the textual content of elements of the invoice, such as characters, numbers, etc. As another example, the processing device can associate each of the elements with one or more data types, such as “character string,” “numerical data,” “integer,” “decimal,” etc. As yet another example, the processing device can determine positional information related to each of the elements. In one embodiment, positional information related to a data field can include data (e.g., coordinates) about a location of the element in the image and/or locations of geometric structures (e.g., tables and other tabular structures) in the image.

At block 330, the processing device can recognize order items of the purchase order and data fields of each order item.

The order items can be recognized by performing operations 332-338 in some embodiments. At block 332, the processing device can identify a portion of the image containing a tabular structure of data. For example, the processing device can identify a portion of the image that contains more data fields than the other portions of the image. In one example, a portion of image 200 can be identified as containing a tabular structure of data 220.

At block 334, the processing device can identify one or more header elements for the data fields in the tabular structure. In one embodiment, each of the header elements can include a description of one or more data fields, such as “production code,” “description of goods,” “quality,” “unit,” “unit price,” “value-added tax (VAT),” “total,” “net total value,” “total amount excluding VAT,” “VAT Rate,” “tax,” etc. Alternatively, a header element can correspond to a column that does not have a specified description (e.g., a column may correspond to a product code without having the actual product code description). Upon identifying such a header element, the processing device can associate the header element with a description (e.g., “product code”).

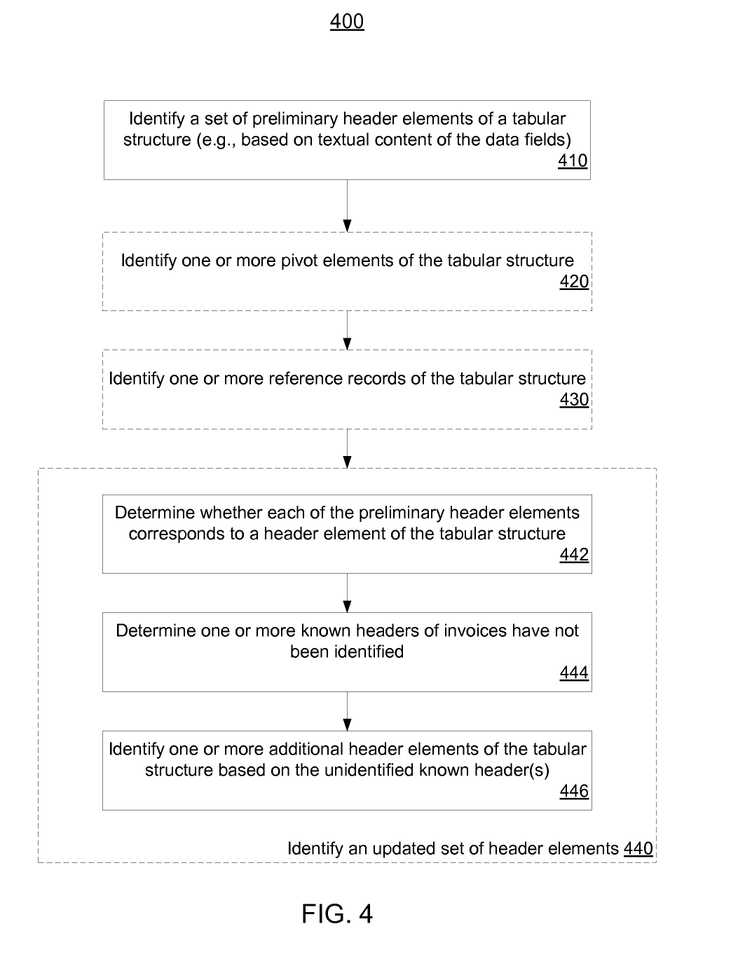

In one embodiment, the processing device can identify the header elements by performing one or more operations described below in connection with FIG. 4. In some embodiments, upon identifying one or more header elements, the processing device can associate each of the identified header element with one or more data types. For example, a header element of “description of goods” can be associated with a data type of “character string.” As another example, a header element of “unit” can be associated with a data type of “numerical data” and/or “integer.”

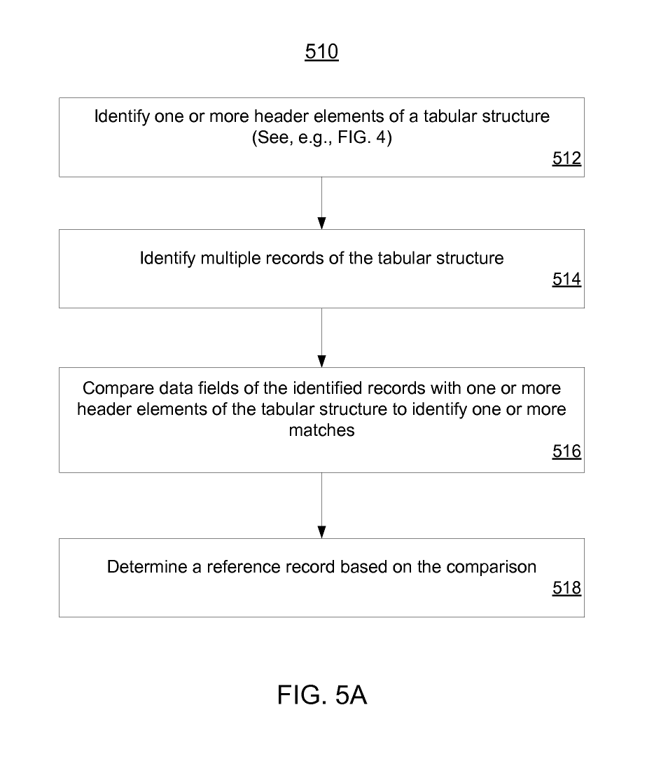

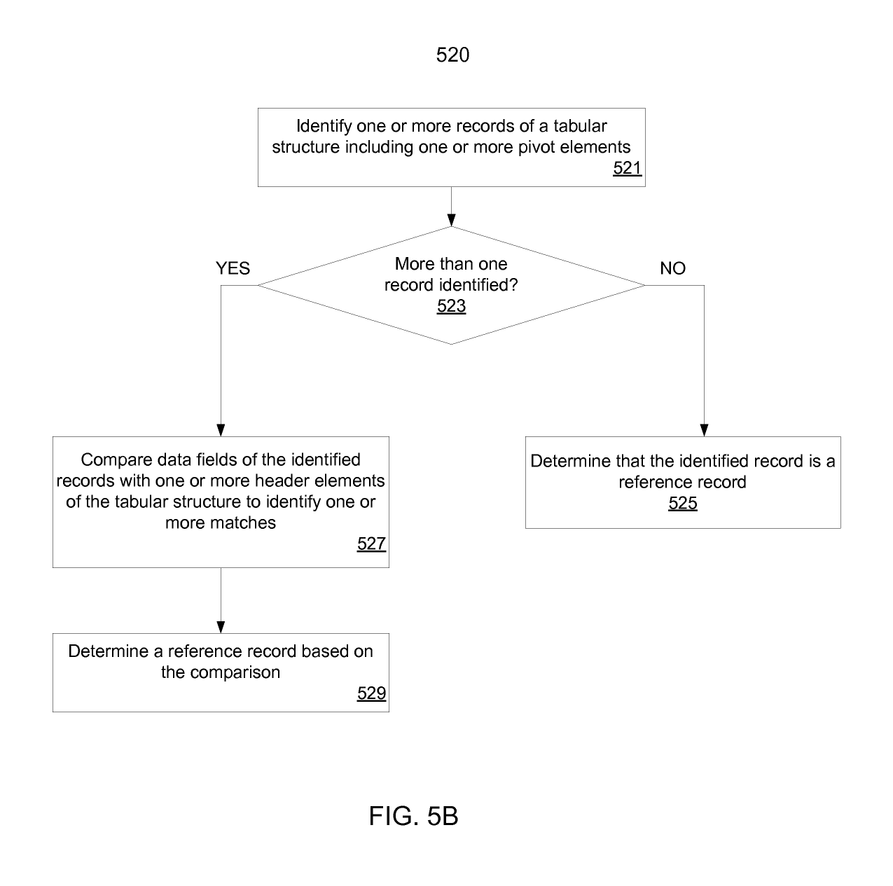

After identifying the header elements of the tabular structure, the processing device can identify records in the tabular structure that represent individual order items of the purchase order. In some implementations, the processing device can perform this identification by first finding a record that is the best candidate for representing an order item, and then using this record as a reference (or model) for identifying other records in the tabular structure that represent order items of the purchase order. In particular, at block 336, the processing device can determine a reference record of the tabular structure that corresponds to an order item. The reference record can include one or more data fields and can be associated with one or more data types. In some embodiments, the processing device can determine the reference record based on the identified header elements, as will be discussed in more detail below in connection with FIG. 5.

As another example, for each or some records of the tabular structure, the processing device can determine a likelihood that the record is a reference record. In one embodiment, the likelihood can be determined based on one or more predetermined computer-implemented instructions that define a set of features of a reference record. In another embodiment, the likelihood can be determined using a classifier that can determine whether a given record of the tabular structure is a reference record. In some embodiments, the classifier can be trained using any suitable machine learning technique or combination of techniques (e.g., Bayesian networks, support vector machines, etc.).

At block 338, the processing device can correlate the other records with the reference record to identify remaining order items in the invoice. For example, the other records can be correlated with the reference record by performing one or more operations as described below in connection with FIG. 6.

At block 340, the processing device can recognize other data fields of the invoice that contain data about the purchase order. For example, the processing device can recognize one or more data fields that correspond to a purchase order number, a total amount of the purchase order, a discount applied to the total amount, a tax rate, etc. The processing device can then extract data items including the content (e.g., characters, numbers, etc.) of the recognized data fields.

In one embodiment, the processing device can recognize these other data fields based on a predefined location on the invoice. For example, the processing device can search for data fields corresponding to a total amount of the purchase order in a portion of the image below the tabular structure.

In one embodiment, the processing device can identify a first data field associated with a character data type (e.g., “character string”) that is positioned next to a second data field associated with a numeric data type (e.g., “numerical data,” “integer,” “decimal,” etc.), and determine whether the first data field includes a description consistent with the data type of the second data field. For example, the processing device can identify a first data field including a description of “discount” and a second data field containing a number. The processing device can then determine that the first data field includes a description consistent with the data type of the second data field in response to determining that the second data field is associated with a data type of “decimal,” which is consistent with “discount.”

In one embodiment, the processing device can identify a first data field of a character data type that is positioned next to a second data field of a numeric data type, and determine whether the first data field includes a description indicative of a total amount, such as “invoice total,” “taxes,” “net total,” “total amount excluding taxes,” “discount,” etc. The processing device can also verify that the total amount was recognized correctly by combining certain identified data fields according to a formula and comparing a result with the total amount. For example, upon identifying data fields next to a description of “taxes,” a description of “net total,” and a description of “invoice total,” the processing device can determine whether data in the data fields can be combined according to the following formula: “net total”+“taxes”×“net total”=“invoice total.” If so, the processing device can determine whether the result of such a combination is equal to the total amount. As another example, upon identifying data fields next to a description of “discount,” a description of “net total,” and a description of “invoice total,” the processing device can determine whether data in the data fields can be combined according to the following formula: “net total”+“discount”×“net total”=“invoice total.” If so, the processing device can determine whether the result of such a combination is equal to the total amount.

FIG. 4 is a flow diagram illustrating a method 400 for identifying header elements of a purchase order according to an embodiment of the disclosure. Method 400 and/or each of its individual functions, routines, subroutines, or operations may be performed by one or more processing devices of a computer system (e.g., computing device 100 of FIG. 1) executing the method. In some embodiments, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

At block 410, a processing device can identify a set of preliminary header elements of a purchase order of an invoice. More particularly, the processing device can identify one or more data fields of the tabular structure (e.g., tabular structure 220 of FIG. 2) as corresponding to a preliminary header element of the purchase order. For example, the processing device can search for a portion of the tabular structure (e.g., a horizontal portion) that contains more data fields associated with a data type of “character string” than other portions of the image. The processing device can then identify data fields contained in the horizontal portion of the image as corresponding to one or more preliminary header elements. In a more particular example, as shown in FIG. 2, a record of tabular structure 220 may contain data fields “product code,” “description of goods,” “quantity,” “unit,” “unit price,” “VAT,” and “total,” each of which is associated with a data type of “character string.” In such an example, the processing device may determine that this record of tabular structure 220 contains more data fields associated with a data type of “character string” than other records of tabular structure 220 and can then determine that each data field of this record corresponds to a preliminary header element.

As another example, the processing device can identify one or more preliminary header elements of the tabular structure based on textual content of data fields of the tabular structure. More particularly, for example, the processing device searches for data fields containing one or more keywords related to one or more header elements of a purchase order. Examples of such keywords can include “product code,” “description,” “description of goods,” “product,” “quantity,” “unit,” “price,” “unit price,” “total,” etc. In one embodiment, one or more of the keywords can be provided by a user and/or can be stored in a database. In another embodiment, one or more of the keywords can be obtained by the processing device (or other suitable device) during recognition of previous invoices and can then be stored in a database.

In some embodiments, upon identifying one or more preliminary header elements (e.g., by identifying data fields corresponding to the preliminary header elements), the processing device can prompt a user to verify the identified preliminary header elements (e.g., by presenting one or more graphical user interfaces). For example, the processing device can prompt the user to indicate whether an identified preliminary header element is a header element of the purchase order. As another example, the processing device can prompt the user to select one or more data fields of the tabular structure as corresponding to header elements of the purchase order.

The preliminary header elements found at block 410 may or may not include all of the header elements associated with the purchase order. In order to find the remaining header elements, the processing device can identify blocks of data in the tabular structure that can each represent with a high degree certainty a data field of an order item of the purchase order, as determined by the processing device. In particular, at 420, the processing device can identify one or more pivot elements of the tabular structure. Pivot elements can represent data fields arranged randomly across the tabular structure. Alternatively, some or all of the pivot elements can be part of one or more rows of the tabular structure, one or more columns of the tabular structure, etc.

In one embodiment, in order to determine that a pivot element represents with a high degree certainty a data field of an order item, the processing device can identify data fields that contain numerical data as being pivot elements if the data types of these data fields correspond to data fields that are usually contained in various invoices (e.g., “order item quantity” having a data type of “integer,” “unit price” having a data type of “decimal,” “order item total” having a data type of “decimal,” etc.).

In addition or alternatively, the processing device can determine that a pivot element represents with a high degree certainty a data field of an order item based on a relationship between the sets of data fields containing numerical data. For example, the processing device can determine a mathematical relationship between multiple sets of data fields, such as each of a first set of data fields being a product of one of a second set of data fields multiplied by one of a third set of data fields. The processing device then determines that the multiple sets of data fields are pivot elements in response to determining that the determined mathematical relationship corresponds to a predefined formula (e.g., a total price of a given product associated with an order item being a result of a unit price of the product multiplied by the quantity).

At block 430, the processing device can identify one or more reference records of the tabular structure. In one embodiment, a reference record can be identified by performing one or more operations described below in connection with FIGS. 5A and/or 5B. In some embodiments, blocks 420 and/or 430 can be skipped.

At block 440, the processing device can identify an updated set of header elements. The updated set of header elements can be identified based on one or more of the preliminary header elements, the pivot elements, the reference records, etc. In some embodiments, the updated set of header elements can be identified by performing one or more of blocks 442, 444, and 446.

At block 442, the processing device determines whether each of the preliminary header elements identified at block 410 should be included in the updated set of header element. In one embodiment, the processing device makes the determination based on positional information of corresponding pivot elements. For example, the processing device can compare a location of the pivot element and a location of a given preliminary header element and determine whether the position of the preliminary header element is above the position of the pivot element and is aligned with the position of the pivot element. If so, the processing device can determine that the preliminary header element corresponds to a header element of the tabular structure. Alternatively, the processing device can determine that the preliminary header element should not be included in the updated set of header element in response to determining that the header element is not aligned with the corresponding pivot element.

In one embodiment, the processing device can determine a correlation between a given preliminary header element and the pivot elements and can then determine whether the preliminary header element should be divided into several header elements of the tabular structure based on the correlation. In some embodiments, the correlation indicates a number of the pivot elements that correspond to a given preliminary header element. For example, the processing device can determine whether a given preliminary header element corresponds to multiple pivot elements. In response to determining that the preliminary header element corresponds to multiple pivot elements, the processing device can determine that the preliminary header element corresponds to multiple header elements of the tabular structure and can divide the preliminary header element into a number of header elements. More particularly, for example, in response to determining that the preliminary header element corresponds to a given number of pivot elements (e.g., two columns of data fields), the processing device can divide the preliminary header element into multiple header elements based on the number of pivot elements that correspond to the preliminary. In some embodiments, the correlation indicates that multiple preliminary header elements (e.g., “unit” and “price”) correspond to one pivot element (e.g., a column of data fields). The processing device then determines that the multiple preliminary header elements should be combined into one header element of the tabular structure (e.g., “unit price”).

In one embodiment, the processing device can determine whether one or more of the preliminary header elements correspond to one or more header elements of the tabular structure based on distances between the preliminary header elements. More particularly, for example, the processing device can identify a first distance between a first preliminary header element (e.g., “unit”) and a second preliminary header element (e.g., “price”) and a second distance between the second preliminary header element (e.g., “price”) and a third preliminary header element (e.g., “VAT”). The processing device can then compare the two distances to determine whether the two distances are the same. For example, a distance between two preliminary header elements can be measured by the number of spaces between the preliminary header elements. In one example, two distances can be determined as the same when a difference between the two distances (e.g., an absolute difference, a square of an absolute difference, etc.) is not greater than a predetermined threshold. In response to determining that the two distances are the same, the processing device can determine that each of the first preliminary header element and the second preliminary header element corresponds to a header element of the tabular structure, respectively. Alternatively, the processing device can determine that the first preliminary header element and the second preliminary header element should be combined into one header element of the tabular structure in response to determining that the first distance is shorter than the second distance.

In one embodiment, the processing device can determine whether one or more of the preliminary header elements correspond to header elements of the tabular structure based on one or more reference records. For example, the processing device can compare positional information related to a reference record and positional information related to each of the preliminary header elements. In some embodiments, the processing device determines that a given preliminary header element is not a header element of the tabular structure in response to determining that the preliminary header element is not aligned with a corresponding data field of a reference record. Alternatively, the processing device determines that the preliminary header element is a header element of the tabular structure in response to determining that the preliminary header element is aligned with a corresponding data field of the reference record.

At block 444, the processing device can determine that one or more known invoice headers have not been identified. Examples of a known invoice header include “description of goods,” “quantity,” “unit price,” “total,” and/or other header that is regarded as being a common invoice header. In some embodiments, the processing device can access a database that stores information related to known headers to obtain information about known invoice headers associated with one or more users. In some embodiments, information related to one or more known invoice headers can be provided by a user and can then be stored in the database.

At block 446, the processing device can identify one or more additional header elements of the tabular structure based on the unidentified known invoice header(s). More particularly, the processing device can identify one or more data fields of the tabular structure as corresponding to the unidentified known invoice header(s). For example, the processing device can search for data fields that contain a description indicative of an unidentified known header. More particularly, for example, upon determining that a known header of “description of goods” has not been identified, the processing device can search for data fields of the tabular structure that contain one or more keywords related to “description of goods” (e.g., “description,” “description of goods,” “product description,” etc.).

Alternatively or additionally, the processing device searches for data fields associated with a data type (e.g., “character string”) defined by a known invoice header (e.g., “description of goods”). In one embodiment, the processing device can search for a wide portion of data fields in the tabular structure (e.g., a portion 227 of an image 200 as shown in FIG. 2). The processing device then determines a likelihood that the data fields correspond to the known header. In one embodiment, the likelihood can be determined based on one or more predetermined computer-implemented instructions that define a set of features of data fields corresponding to the known header. In another embodiment, the likelihood can be determined using a classifier that can determine whether a given data field of the tabular structure corresponds to the known header. In some embodiments, the classifier can be trained using any suitable machine learning technique or combination of techniques (e.g., Bayesian networks, support vector machines, etc.).

As another example, the processing device first identifies one or more data fields positioned at a typical location of the invoice that may include a known header (e.g., the leftmost column of the tabular structure for data fields corresponding to “product code”). The processing device then determines a likelihood that the data fields correspond to the known header. In one embodiment, the likelihood can be determined based on one or more predetermined computer-implemented instructions that define a set of features of data fields corresponding to the known header. In another embodiment, the likelihood can be determined using a classifier that can determine whether a given data field of the tabular structure corresponds to the known header. In some embodiments, the classifier can be trained using any suitable machine learning technique or combination of techniques (e.g., Bayesian networks, support vector machines, etc.).

As yet another example, the processing device can identify one or more unidentified header elements based on known positional information related to known invoice headers. More particularly, for example, the processing device may determine that data fields corresponding to “description of goods” often are located between data fields corresponding to “product code” and data fields corresponding to “quantity.” The processing device then determines that a header element between header element “product code” and header element “quantity” is “description of goods.” Additionally, the processing device can determine whether a data type defined by the determined header element corresponds to a data type associated with a set of data fields located below the determined header element. For example, the processing device determines that header “description of goods” defines a data type of “character string” and that a set of data fields located below the determined header are associated with a data type of “character string.” The processing device then determines that the determined header element is “description of goods.”

FIG. 5A is a flow diagram illustrating a method 510 for identifying a reference record of a tabular structure of data representing a purchase order according to an embodiment of the disclosure. Method 510 and/or each of its individual functions, routines, subroutines, or operations may be performed by one or more processors of the computer system (e.g., computer device 100 of FIG. 1) executing the method. In some embodiments, method 510 may be performed by a single processing thread. Alternatively, method 510 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 512, a processing device can identify one or more header elements of a tabular structure. In one embodiment, the header elements can be identified by performing one or more operations described above in connection with FIG. 4.

At block 514, the processing device can identify multiple records of the tabular structure. For example, the processing device can identify records containing data fields that are located below the identified header elements. As another example, the processing device can identify records containing a predetermined number of data fields (e.g., a threshold number of data fields, the most data fields, etc.).

At block 516, the processing device can compare data fields of the identified records with one or more header elements to identify one or more matches. For example, the processing device can compare data types associated with data fields of an identified record to data types defined by the header elements. The processing device then identifies a match between the record and the header elements upon identifying a data field of the record that is associated with a data type (e.g., “character string”) defined by one of the identified header elements (e.g., “description of goods”).

As another example, the processing device can compare positional information related to the header elements with positional information related to data fields of a record. More particularly, for example, the processing device determines whether each data field of a record is positioned below and is aligned (vertically) with a corresponding identified header. The processing device then identifies a match in response to determining that a data field of the record is positioned below and is aligned with the identified header.

At block 518, the processing device can determine a reference record based on the comparison. In one embodiment, a reference record contains data fields that have a higher number of matches with the identified header elements than other records in the tabular structure. In another embodiment, the processing device can determine that a record of the tabular structure is a reference record in response to detecting a predetermine number of matches between data fields of the record and data fields of the header elements (e.g., the most matches, the second most matches, a threshold number of matches, etc.).

FIG. 5B is a flow diagram illustrating a method 520 for identifying a reference record using pivot elements of a purchase order according to an embodiment of the disclosure. Method 520 and/or each of its individual functions, routines, subroutines, or operations may be performed by one or more processing devices of the computer system (e.g., computing device 100 of FIG. 1) executing the method. In some embodiments, method 510 may be performed by a single processing thread. Alternatively, method 520 may be performed by two or more processing threads, each thread executing one or more individual functions, routines, subroutines, or operations of the method. In an illustrative example, the processing threads implementing method 520 may be synchronized (e.g., using semaphores, critical sections, and/or other thread synchronization mechanisms). Alternatively, the processing threads implementing method 520 may be executed asynchronously with respect to each other.

At block 521, a processing device can identify one or more records of a tabular structure including one or more pivot elements. In some embodiments, the pivot elements can be identified by performing one or more operations described above in connection with FIG. 4. In one example, the processing device can identify a record that contains a predetermined number of pivot elements (e.g., a threshold number of pivot elements, the most pivot elements, etc.).

At block 523, the processing device can determine whether more than one record was identified at block 521. In one embodiment, in response to determining that one record was identified at 521, the processing device can proceed to block 525 and can determine that the identified record is a reference record.

Alternatively, in response to determining that more than one record was identified at block 521, the processing device can proceed to block 527 and compare data fields of the identified records with one or more header elements of the tabular structure to identify one or more matches. For example, the processing device can compare data types associated with data fields of an identified record to data types defined by the header elements. The processing device then identifies a match between the record and the header elements upon identifying a data field of the record that is associated with a data type defined by one or more the header elements.

As another example, the processing device can compare positional information related to the header elements with positional information related to data fields of a record. More particularly, for example, the processing device determines whether each data field of a record is positioned below and is aligned (vertically) with a corresponding identified header. The processing device then identifies a match in response to determining that a data field of the record is positioned below and is aligned with the identified header.

At block 529, the processing device can determine a reference record based on the comparison. In one embodiment, a reference record contains data fields that have a higher number of matches with the identified header elements than other records in the tabular structure. In another embodiment, the processing device can determine that a record of the tabular structure is a reference record in response to detecting a predetermine number of matches between data fields of the record and data fields of the header elements (e.g., the most matches, the second most matches, a threshold number of matches, etc.).

FIG. 6 is a flow diagram illustrating a method 600 for correlating other records with a reference record for invoice recognition according to an embodiment of the disclosure. Method 600 and/or each of its individual functions, routines, subroutines, or operations may be performed by one or more processing devices of a computer system (e.g., computing device 100 of FIG. 1) executing the method. In some embodiments, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other.

At block 611, a processing device identifies a reference record of a tabular structure. In some embodiments, the reference record can be identified by performing one or more operations as described above in connection with FIGS. 5A and 5B. The reference record corresponds to an order item of a purchase order in some embodiments (e.g., an order item 230a-b of FIG. 2).

At block 613, the processing device identifies one or more candidate records that match the reference record. In one embodiment, a candidate record can be a record that contains one or more pivot elements (e.g., one or more pivot elements recognized by performing one or more operations as described above in connection with the block 430 of FIG. 4). In another embodiment, the processing device can select a record of the tabular structure as a candidate record in response to determining that the record contains one or more data fields positioned below and aligned with one or more header elements of the tabular structure. In one embodiment, the header elements can be recognized by performing one or more operations described above in connection with FIGS. 3 and 4.

In some embodiments, the processing device can identify a candidate record as matching to the reference record in response to identifying a predetermined number of matches between candidate record and the reference record (e.g., a threshold number of matches, the most matches among multiple candidate records, etc.). The processing device can identify a match between a candidate record and a reference record by comparing information related to data fields of the candidate record with information related to data fields of the reference record. For example, the processing device can compare data types associated with data fields of the candidate record to data types associated with data fields of the reference record. The processing device then identifies a match between the candidate record and the reference record upon identifying a data field of the candidate record and a corresponding data field of the reference record (a data field of the reference record positioned in a column of the tabular structure including the data field of the candidate record) that are associated with the same data type.

As another example, the processing device can compare positional information related to a candidate record with positional information related to a reference record. More particularly, for example, the processing device identifies a match between the candidate record and the reference record in response to determining that a data field of the candidate record is positioned in a column of the tabular structure including a data field of the reference record.

At block 615, the processing device can determine a structure pattern of order items in the tabular structure. The structure pattern may indicate a number of records in an order item, positioning of records relative to each other, specific data fields included in each record, etc. For example, the structure pattern can indicate that an order item includes one or more reference records and/or one or more other records. For example, as shown in FIG. 6B, a pattern 620 may indicate that an order item only includes a single reference record 621. As another example, a pattern 630 of FIG. 6B may indicate that an order item includes a reference record 631, and additional records 633 and 635. As shown in FIG. 6B, record 633 and record 635 may be located below reference record 631. As yet another example, pattern 640 may indicate that an order item includes a reference record 641, and additional records 643 645, where record 643 is located above reference record 641, and record 645 is located below reference record 641. Each of records 621, 631, 633, 635, 641, 643, and 645 includes one or more data fields (not shown).

In some embodiments, the structure pattern may be applicable to multiple order items of a tabular structure. For example, as shown in FIG. 6C, pattern 630 is applicable to multiple order items of a tabular structure 650. As another example, as shown in FIG. 6C, pattern 640 is applicable to multiple order items of a tabular structure 660.

The processing device can identify a structure pattern for order items using any suitable technique or combination of techniques. For example, the processing device can select, from the candidate records identified at 613, a candidate record that is positioned closest to the reference record identified at 611. The processing device can then determine whether there is any unidentified record positioned between the reference record identified at 611 and the selected candidate reference record. In one embodiment, in response to determining that no unidentified record is positioned between the reference record and the selected candidate record, the processing device can determine that each order item of the purchase order includes a single record.

Alternatively, in response to determining that there is one or more unidentified records positioned between the reference record and the selected candidate record, the processing device can determine that each order item of the purchase order includes multiple records. More particularly, for example, the processing device can determine a number of the unidentified records positioned between the reference record and the selected candidate record (e.g., one record, two records, etc.). The processing device can then determine the number of records contained in each order item based on the number of the unidentified records. For example, in response to detecting two unidentified records positioned between the reference record and the selected candidate record, the processing device can determine that each order item contains three records.

The processing device can determine whether the determined pattern applies to multiple order items of the tabular structure. For example, the processing device may compare information related to data fields in the determined pattern with respective information related to data fields in the records of the order items in the tabular structure to identify one or more matches between the determined pattern and the order items. The information being compared can include, for example, data types of data fields, fonts of date fields, positional information of data fields, recurring data fragments in order items, etc.

In a more particular example, the processing device can compare data types associated with data fields of the determined pattern to data types associated with data fields of one or more records that may correspond to an order item of the tabular structure. The processing device then identifies a match between the determined pattern and the order item upon identifying a data field of the records and a data field of the determined pattern that are associated with the same data type (e.g., “character string”).

In another more particular example, the processing device can compare positional information related to data fields of the determined pattern and positional information related to data fields of one or more records that may correspond to an order item of the tabular structure. More particularly, for example, the processing device determines whether each data field of the records is aligned (vertically) with a data field of the determined pattern. The processing device then identifies a match in response to determining that a data field of the record(s) is aligned with a data field of the determined pattern.

In some embodiments, the processing device can determine a number of matches between the determined pattern and each of the order items of the tabular structure (e.g., one match, two matches, three matches, etc.). The processing device can determine that the determined pattern applies to all of the order items in response to determining that all order items in the tabular structure have approximately the same number of matches with the determined pattern.

If the processing device determines that the determined pattern is applicable to all order items in the tabular data structure, and that the determined pattern is a single-record pattern, then method 610 ends. Alternatively, if the processing device determines that at least some of the order items in the tabular structure correspond to a multi-record pattern, the processing device identifies remaining records of order items having a multi-record pattern (block 617). Various parameters can be used to identify remaining records that belong to the same order item as a certain reference record. These parameters can include, for example, positioning of records relative to each other, distances between the records, etc. For example, the processing device can determine whether the reference record and an unidentified record that is located adjacent to (immediately above or below) the reference record correspond to the same order item. More particularly, for example, the processing device can determine a first distance between the reference record and a record that is located above the reference record (e.g., a distance between a record 653 and a reference record 651 of FIG. 6C, a distance between a record 663 and a reference record 661 of FIG. 6C, etc.). The processing device can also determine a second distance between the reference record and a record that is located below the reference record (e.g., a distance between reference record 651 and a record 655 of FIG. 6C, a distance between reference record 661 and a record 665 of FIG. 6C, etc.). In some embodiments, a distance between two records can be measured by a number of intervening records and/or lines of whitespaces between the records.

The processing device can then compare the two distances to determine whether the records located adjacent to the reference record and the reference record itself correspond to the same order item. In one example, in response to determining that the first distance is the same as the second distance, the processing device determines that the reference record itself (e.g., reference record 661 of FIG. 6C) and both of the records that are located adjacent to the reference record (e.g., record 663 and record 665 of FIG. 6C) correspond to the same order item. In some embodiments, the processing device can determine that the first distance is the same as the second distance in response to determining that a difference between the first distance and the second distance is not greater than a threshold.

In another example, in response to determining that the first distance is greater than the second distance (e.g., a distance between the first distance and the second distance being greater than a threshold), the processing device determines that the record that is located below the reference record (e.g., record 655 of FIG. 6C) and the reference record itself (e.g., record 651 of FIG. 6C) correspond to the same order item. Additionally, the processing device can determine that the record that is located above the reference record (e.g., record 653 of FIG. 6C) and the reference record itself (e.g., record 655 of FIG. 6C) do not correspond to the same order item.

In yet another example, in response to determining that the second distance is greater than the first distance (e.g., a distance between the first distance and the second distance being greater than a threshold), the processing device determines that the record that is located above the reference record and the reference record itself correspond to the same order item. Additionally, the processing device can determine that the record that is located below the reference record and the reference record itself do not correspond to the same order item.

FIG. 7 illustrates a diagrammatic representation of a machine in the example form of a computer system 700 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 700 includes a processing device 702 (e.g., processor, CPU, etc.), a main memory 704 (e.g., read-only memory (ROM), flash memory, dynamic random access memory (DRAM) (such as synchronous DRAM (SDRAM) or DRAM (RDRAM), etc.), a static memory 706 (e.g., flash memory, static random access memory (SRAM), etc.), and a data storage device 718, which communicate with each other via a bus 708.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic 726 for performing the operations and steps discussed herein.

The computer system 700 may further include a network interface device 722 communicably coupled to a network 764. The computer system 600 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 718 may include a machine-accessible storage medium 724 on which is stored software 726 embodying any one or more of the methodologies of functions described herein. The software 726 may also reside, completely or at least partially, within the main memory 704 as instructions 726 and/or within the processing device 702 as processing logic 726 during execution thereof by the computer system 700; the main memory 704 and the processing device 702 also constituting machine-accessible storage media.

The machine-readable storage medium 724 may also be used to store instructions 726 to process electronic documents for invoice recognition, such as the application 190 as described above with respect to FIG. 1, and/or a software library containing methods that call the above applications. While the machine-accessible storage medium 724 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

In the foregoing description, numerous details are set forth. It will be apparent, however, that the disclosure may be practiced without these specific details. In some instances, well-known structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending,” “receiving,” “creating,” “identifying,” “providing,” “executing,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “first,” “second,” “third,” “fourth,” etc. as used herein are meant as labels to distinguish among different elements and may not necessarily have an ordinal meaning according to their numerical designation.

The disclosure also relates to an apparatus for performing the operations herein. This apparatus may be specially constructed for the purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the method steps. The structure for a variety of these systems will appear as set forth in the description below. In addition, the disclosure is not described with reference to any particular programming language. It will be appreciated that a variety of programming languages may be used to implement the teachings of the disclosure as described herein.

The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

What is claimed is:

1. A method, comprising:
receiving, using a processing device, an image of an invoice for at least one purchase order;
identifying, using the processing device, a portion of the image comprising a tabular structure having a plurality of records, the tabular structure storing data representing a plurality of order items of the at least one purchase order, the plurality of order items having a plurality of data fields, wherein each order item comprises one or more of the plurality of records and one or more of the plurality of data fields; and
recognizing, using the processing device, the plurality of order items in the image of the invoice, wherein recognizing the plurality of order items comprises:
identifying a plurality of header elements for the plurality of data fields based at least in part on textual content of the invoice;
determining a reference record having data fields that have a higher number of matches with the identified header elements than other records in the tabular structure, the reference record corresponding to one of the plurality of order items; and
correlating the other records with the reference record to identify remaining order items in the invoice.

2. The method of claim 1, further comprising:
receiving, from a computing device associated with a user, a request for data representing one or more elements of the purchase order, wherein the one or more elements of the purchase order comprise at least one of a purchase order number, a total amount, or a header element;
recognizing, using the processing device, one or more of the data fields corresponding to the one or more elements of the purchase order; and
transmitting, data associated with the recognized data fields to the computing device.

3. The method of claim 1, further comprising:
receiving, from a computing device associated with a user, at least one keyword;
storing, the keyword in a non-transitory data storage; and
identifying the plurality of header elements based at least in part on the stored keyword.

4. The method of claim 1, wherein the plurality of order items are recognized by the processing device automatically without user interaction.

5. The method of claim 1, further comprising:
identifying a first data field associated with a character data type and a second data field associated with a numeric data type;
determine whether the first data field includes a description indicative of a total amount; and
verifying that the total amount was recognized correctly by combining a third data field and a fourth data field according to a formula and comparing a result with the total amount.

6. The method of claim 1, further comprising identifying a total amount based on a predefined location on the invoice.

7. The method of claim 1, further comprising:
determining, for each of the plurality of records, a likelihood that the record is a reference record based on a plurality of predetermined computer-implemented instructions; and
determining, using the processing device, the reference record based at least in part on the likelihood.

8. The method of claim 1, wherein the header elements comprise a subset of the plurality of data fields.

9. The method of claim 1, wherein the header elements correspond to a plurality of descriptions of the plurality of data fields.

10. The method of claim 1, further comprising:
determining a plurality of preliminary header elements of the plurality of data fields based on at least one of a record in the tabular structure that contains more data fields than other records in the tabular structure, or one or more keywords associated with known header elements; and
identifying the plurality of header elements based at least in part on the plurality of preliminary header elements.

11. The method of claim 10, further comprising:
determining, using the processing device, a first distance between a first preliminary header element and a second preliminary header element and a second distance between the second preliminary header element and a third preliminary header element;
comparing the first distance and the second distance; and
determining whether the second preliminary header element corresponds to more than one of the plurality of header elements based at least in part on the comparison, wherein the plurality of preliminary header elements comprise the first preliminary header element, the second preliminary header element, and the third preliminary header element.

12. The method of claim 10, further comprising:
recognizing a first set of the data fields and a second set of the data fields that contain numerical data;
determining a mathematical relationship between the first set of the data fields and the second set of the data fields; and
determining that the first set of the data fields and the second set of the data fields are pivot elements of the plurality of data fields if the mathematical relationship corresponds to a predefined formula, wherein the pivot elements correspond to data about the purchase order.

13. The method of claim 12, further comprising:
comparing positional information related to the preliminary header elements with positional information related to the pivot elements; and
determining the plurality of header elements based at least in part on the comparison.

14. The method of claim 12, further comprising:
determining a correlation between each of the preliminary header elements and the pivot elements, wherein the correlation indicates a number of the pivot elements that correspond to each of the plurality of preliminary header elements;
determining, using the processing device, whether each of the plurality of preliminary header elements corresponds to more than one of the plurality of header elements based at least in part on the correlation.

15. The method of claim 1, wherein determining the reference record comprises:
identifying a plurality of records of the tabular structure, wherein each of the plurality of records includes a plurality of pivot elements of the tabular structure; and
selecting one of the plurality of records that includes the highest number of data fields that match the identified header elements.

16. The method of claim 15, wherein correlating the other records with the reference record to identify remaining order items in the invoice comprises:
identifying a plurality of candidate records that match the reference record;
selecting, from the plurality of candidate records, a candidate record positioned closest to the reference record; and
determining whether at least one unidentified record is positioned between the reference record and the selected candidate record.

17. The method of claim 16, further comprising determining that each of the plurality of order items comprises at least one additional record in response to determining that at least one unidentified record is positioned between the reference record and the selected candidate record.

18. The method of claim 16, further comprising determining that each of the plurality of order items includes one record in response to determining that no unidentified record is positioned between the reference record and the selected candidate record.

19. The method of claim 1, further comprising:
recognizing, using the processing device, a subset of the data fields that correspond to a plurality of purchase order numbers;
receiving, from a computing device associated with a user, a request for purchase order numbers associated with the invoice; and
transmitting, using the processing device, data associated with the subset of the data fields to the computing device.

20. The method of claim 1, wherein recognizing the plurality of order items further comprises recognizing previously unidentified header elements, recognizing the previously unidentified header elements comprising:
determining that a location of an unidentified header element corresponds to a typical location of a known invoice header; and
verifying a data type of a data field located below the unidentified header element in a corresponding column to confirm that the unidentified header element is the known invoice header.

21. A system, comprising:
a memory;
a processing device communicably coupled to the memory to:
receive an image of an invoice for at least one purchase order;
identify a portion of the image comprising a tabular structure having a plurality of records, the tabular structure storing data representing a plurality of order items of the at least one purchase order, the plurality of order items having a plurality of data fields, wherein each order item comprises one or more of the plurality of records and one or more of the plurality of data fields; and
recognize the plurality of order items in the image of the invoice, wherein recognizing the plurality of order items comprises:
identify a plurality of header elements for the plurality of data fields based at least in part on textual content of the invoice;
determine a reference record having data fields that have a higher number of matches with the identified header elements than other records in the tabular structure, the reference record corresponding to one of the plurality of order items; and
correlate the other records with the reference record to identify remaining order items in the invoice.

22. A non-transitory machine-readable storage medium including instructions that, when accessed by a processing device, cause the processing device to perform operations comprising:
receiving an image of an invoice for at least one purchase order;
identifying a portion of the image comprising a tabular structure having a plurality of records, the tabular structure storing data representing a plurality of order items of the at least one purchase order, the plurality of order items having a plurality of data fields, wherein each order item comprises one or more of the plurality of records and one or more of the plurality of data fields; and
recognizing the plurality of order items in the image of the invoice, wherein recognizing the plurality of order items comprises:
identifying a plurality of header elements for the plurality of data fields based at least in part on textual content of the invoice;
determining a reference record having data fields that have a higher number of matches with the identified header elements than other records in the tabular structure, the reference record corresponding to one of the plurality of order items; and
correlating the other records with the reference record to identify remaining order items in the invoice.
